(19) United States
(12) Patent Application Publication
(10) Pub. No.: US 2025/0300412 A1
(43) Pub. Date: Sep. 25, 2025

(54) Coaxial Contact System and Method for Electrically Connecting Two Outer Conductors

(71) Applicant: TE Connectivity Solutions GmbH, Schaffhausen (CH)

(72) Inventors: Kevin KEIL, Schaffhausen (CH); Uwe BLUEMMEL, Schaffhausen (CH); Erik GLOMBITZA, Schaffhausen (CH)

(73) Assignee: TE Connectivity Solutions GmbH, Schaffhausen (CH)

(21) Appl. No.: 19/082,245

(22) Filed: Mar. 18, 2025

(30) Foreign Application Priority Data
Mar. 20, 2024 (DE) 102024107960.6

(51) Int. Cl. H01R 24/40; H01R 43/04; H01R 103/00

(52) U.S. Cl. CPC H01R 24/40; H01R 43/04; H01R 2103/00

(57) ABSTRACT

A coaxial contact system and a method for electrically connecting a first outer conductor of a first coaxial conductor to a second outer conductor of a second coaxial conductor. The coaxial contact system for electrically connecting a first outer conductor of a first coaxial conductor to a second outer conductor of a second coaxial conductor includes an inner contact sleeve, which forms a support sleeve, and an outer contact sleeve, which at least partially surrounds the inner contact sleeve and forms a crimp sleeve which is crimped around the first and second outer conductors in a final assembled state. The inner contact sleeve and the outer contact sleeve are configured such that the first outer conductor is arranged in an axial direction or a radial direction next to the second outer conductor on the inner contact sleeve.

### CROSS REFERENCE TO RELATED APPLICATIONS

This application claims priority to and the benefit of German Patent Application No. 102024107960.6 filed Mar. 20, 2024, which is hereby incorporated by reference in its entirety.

### BACKGROUND OF THE INVENTION

The present invention relates to a coaxial contact system and to a method for electrically connecting a first outer conductor of a first coaxial conductor to a second outer conductor of a second coaxial conductor.

The available principles are particularly preferred for electrical contacting of shieldings, but can also be used in general for electrical connection of the outer conductors of any type of coaxial conductors.

Electrical cables, the inner conductors of which carry high voltages, require electrical shielding to prevent interference with nearby electrical or electronic components. In addition, the shielding can also be provided to protect the inner conductor against external electrical and/or magnetic interference. For the purpose of shielding, for example, a shielding braid is provided, which consists of a plurality of strands of an electrically conductive material that encases the electrical inner conductor. In this case, the shielding braid is usually located inside a cable sheath and is arranged between a primary insulation, also referred to as inner sheath, which is arranged between the inner conductor and the shielding braid, and a secondary insulation, also referred to as outer sheath or cable sheath, which surrounds the shielding braid on the outside. To increase the shielding effect of the shielding braid, a shielding film can also be provided either between the primary insulation and the shielding braid or between the shielding braid and the secondary insulation. This is usually a copper-clad aluminum film. This shielding film does not transmit any currents worth mentioning and, in the event of contact with the shielding braid, is not contacted but cut off when the shielding braid is exposed.

To ensure the shielding of the inner conductor and the equipotential bonding of the shielding braid, it is necessary that the shielding braid can be connected to ground in the end regions of the electrical cable. For this purpose, at least one contact element is usually provided at each end of the cable, which is electrically conductively connected to the shielding braid and can be connected to ground. Furthermore, if two shielded cables are connected, it must be ensured that the shieldings are connected to each other. This must also be ensured when connecting a shielded cable to a contact element, for example by connecting the shielding plate of a connector to the cable shielding.

For example, known methods for connecting a copper shielding braid to a contact element are realized by sliding a support sleeve onto the cable's secondary insulation and folding the exposed shielding braid back over the support sleeve. The contact part is then guided over the support sleeve and the shielding braid placed on it and then pressure grouted radially, for example, crimped, using a suitable tool for contacting. The crimping process causes the shielding braid to be clamped between the support sleeve and the contact part. These methods can only be used with materials that have good transverse conductivity, since the shielding braid is only punctually crimped.

Aluminum or aluminum alloys are also suitable as a conductive material for shielding braids, which is used in many applications due to its low mass, for example in the automotive sector, especially in electrically powered cars. High-voltage cables with an aluminum braid are cheaper and lighter than cables with a (usually tinned) copper braid. However, such cables with an aluminum braid have significant disadvantages so far.

Aluminum generally has a lower electrical conductivity compared to tinned copper.

When aluminum or aluminum alloy wires are crimped together, these wires already have an oxide layer on their surface that is very difficult to penetrate. Due to the radial crimping, a contacting process commonly used in copper technology for a shielding braid is not able to establish a contact between all aluminum wires of the aluminum shielding braid and the contact element, because the oxide layers forming on the aluminum wires prevent the transverse conductivity in the crimped areas. Thus, through known methods, the oxide layers cannot be broken through for all wires in the shielding braid. In addition, even if the oxide layers are broken through during crimping, new oxide quickly forms again in and around the contact points. It has also been shown that with known contacting methods for aluminum shielding braids, no stable connection can be achieved under temperature change stress.

In order to enable even shielding contact with these materials, known connection methods for aluminum shielding braids use additional measures to ensure that all aluminum wires are contacted and, if necessary, to break up the oxide layer. All of these known solutions, however, still have disadvantages and, in particular, often lead to unsatisfactory results in terms of electromagnetic compatibility (EMC) when compared to conventionally crimped copper braids. In particular, there is a risk that the EMC will deteriorate over time to such an extent that the permissible limits are no longer met.

In addition, many of the known solutions require a relatively large amount of space in the radial direction. This is particularly disadvantageous for an application in the automotive sector.

There is therefore a need for a coaxial contact system that overcomes the disadvantages of the known arrangements and provides electrical contact between two coaxial outer conductors with optimal electromagnetic compatibility in a cost-effective and space-saving manner.

### SUMMARY OF THE INVENTION

This problem is solved by the subject-matter of the independent claims. Preferred further developments of the present invention are the subject-matter of the dependent claims.

The present invention is thereby based on the idea of arranging the first and second outer conductors not radially overlapping one another, but axially or radially adjacent to one another in the radial direction between two contact sleeves and then pressure grouting these by means of a crimping process. In this way, on the one hand, a radially circumferential increased contact pressure can be generated because there is less material between the contact sleeves in the radial direction that has to be pressed together and contacted. On the other hand, the space requirement in the radial direction is reduced, which means that the size of the connectors can be reduced, in particular when they are contacted. It should be mentioned that the two outer conductors do not have to touch each other, and that a space can also be provided.

In particular, the present invention provides a coaxial contact system for electrically connecting a first outer conductor of a first coaxial conductor to a second outer conductor of a second coaxial conductor, wherein the coaxial contact system comprises an inner contact sleeve, which forms a support sleeve, and an outer contact sleeve, which at least partially surrounds the inner contact sleeve and forms a crimp sleeve, which in a final assembled state is crimped around the first and second outer conductors. The inner contact sleeve and the outer contact sleeve are configured such that the first outer conductor is arranged in an axial direction or a radial direction next to the second outer conductor on the inner contact sleeve.

Due to the axial or radial separation of the contact areas to the respective outer conductors, these contact areas can be specially adapted to the properties of the outer conductor to be contacted. It is therefore not necessary for the inner and/or outer contact sleeve to have unchanged properties along its axial extent or around its entire circumference. In particular, materials and/or structures may be provided that vary in the axial or radial direction.

The solution according to the invention can also be used independently of the cable diameter for a wide range of coaxial applications. No adjustments need to be made to the outer conductors to be contacted (e.g. shielding braids, solid tubes or connector shieldings). The inner sleeve and/or the outer sleeve can be coated accordingly, but otherwise be made of inexpensive material.

Alternatively, either the inner or the outer contact sleeve, or both, can also be formed by peripheral areas of the first and/or the second outer conductor. This means that the inner and/or outer contact sleeve can be dispensed with as separate parts if one or both of the outer conductors also take on the mechanical task of an inner support sleeve and/or an outer sleeve to be deformed, in addition to the electrical task. In the event that no separate contact sleeve is provided, the internally located outer conductor forms the inner contact sleeve, which provides the mechanical support, and the externally located outer conductor forms the crimped (deformed) outer contact sleeve.

In other words, a significantly reduced space requirement in the radial direction can also be achieved by configuring the inner contact sleeve and/or the outer contact sleeve in such a way that they are integral with the first outer conductor or the second outer conductor.

According to a preferred development of the coaxial contact system, the inner contact sleeve and/or the outer contact sleeve has/have a microstructured contact area which, in the finally assembled state, electrically contacts the first and/or the second outer conductor. Such a microstructure forms bumps, which can penetrate the electrically insulating surface layers of the outer conductors to be contacted, if present. This significantly reduces the electrical contact resistance at the interface to the outer conductors.

In this case, the microstructured contact area can be at least partially formed integrally with the inner and/or outer contact sleeve. The integral, i.e. one-piece, production of the microstructured contact area with the respective sleeve has the advantage that production and assembly are simplified and electrical conductivity is increased. The microstructured contact area can also be configured as a separate element, such as a screen plate. This has the advantage that a different material can be selected for the microstructured contact area than for the respective sleeve. The two outer conductors can be contacted by microstructured contact areas that differ in the axial direction.

According to a preferred development, the microstructured contact area is at least partially formed as an additional coating of the inner and/or outer contact sleeve. Such a coating is mounted in one work step together with the respective contact sleeve, but can nevertheless be made of a different material from the contact sleeve.

For example, the microstructured contact area can be formed at least partially by embossing, punching, and/or a screen plate. The selection of the most suitable embodiment depends on the type of outer conductors to be contacted and the subsequent application environment.

According to a preferred aspect of the present invention, the microstructured contact area is at least partially formed by a cold sprayed surface structuring. Cold spraying is a coating method in the field of thermal spraying. Compared to conventional methods, cold spraying offers particular advantages because the spray material is neither melted nor fused during the process. This results in a broader and more flexible range of applications than with other thermal processes.

The high kinetic energy of the particles and the associated high degree of deformation on impact with the component generally enable the production of homogeneous and very dense layers, with a variable layer thickness of a few hundredths of a millimeter up to several centimeters.

For example, metallic coatings are produced, the physical and chemical properties of which hardly differ from those of the base material of the respective sleeve. In this context, a process gas, preferably nitrogen or helium, is supplied to a spray gun at a pressure of up to 50 bar and heated to maximum temperatures of up to 1100° C. in the gun housing.

The subsequent expansion of the heated and highly pressurized gas in a convergent-divergent nozzle to ambient pressure causes the process gas to accelerate to supersonic speed and, at the same time, cool to temperatures below 100° C.

The spray powder is injected by means of a powder feed unit and a similar carrier gas in the convergent area of the nozzle and accelerated in the main gas flow to particle velocities of up to 1200 m/s. The particles hit the (often untreated) component surface in the highly focused spray jet, simultaneously deforming the substrate and themselves, and forming a tightly adhering, dense and low-oxide layer with a defined surface roughness.

To facilitate the application of cold sprayed surface structuring, the inner contact sleeve and/or the outer contact sleeve can also be configured in several parts, e.g. by two half shells. However, it is also possible to a limited extent to provide the inner surface of a closed tubular contact sleeve with a cold sprayed surface structuring by directing the particle jet at a shallow angle onto the inner surface.

In the event that the inner contact sleeve and/or the outer contact sleeve are configured such that they are integral with the first outer conductor or the second outer conductor, a microstructured surface can be applied to the separate contact sleeve or also to the first and/or second outer conductor.

The present invention further relates to a method for electrically connecting a first outer conductor of a first coaxial conductor to a second outer conductor of a second coaxial conductor, wherein the method comprises the following steps:
attaching an inner contact sleeve so that it is arranged in a radial direction below the first outer conductor and the second outer conductor,
attaching an outer contact sleeve so that it at least partially surrounds the inner contact sleeve and forms a crimp sleeve, and
crimping the crimp sleeve so that it is crimped onto the first outer conductor and the second outer conductor.
wherein the first outer conductor is arranged on the inner contact sleeve in an axial direction or a radial direction next to the second outer conductor.

Alternatively, a significantly reduced space requirement in the radial direction can also be achieved by configuring the inner contact sleeve and/or the outer contact sleeve in such a way that they are integral with the first outer conductor or the second outer conductor.

For example, in this method, the inner contact sleeve and/or the outer contact sleeve can be provided with a microstructured contact area which, in the finally assembled state, electrically contacts the first and/or the second outer conductor.

According to a preferred example, the microstructured contact area is at least partially integral with the inner and/or outer contact sleeve. Alternatively, a separate part can also be provided that is connected to one of the contact sleeves either before assembly or only by the crimping process.

Furthermore, it may be provided that the microstructured contact area is at least partially formed as an additional coating of the inner and/or outer contact sleeve.

For example, the microstructured contact area can be formed at least partially by embossing, punching, electroplating and/or a separate screen plate.

According to a preferred embodiment, the microstructured contact area is at least partially formed by a cold sprayed surface structuring.

The method according to the above aspects can be used particularly advantageously if the first outer conductor is formed by the shielding of a connector and/or the second outer conductor is formed by the shielding of a cable. In particular, the method can be used advantageously if the cable shielding has an aluminum wire braid.

### BRIEF DESCRIPTION OF THE DRAWINGS

For a better understanding of the present invention, it is explained in more detail by means of the embodiments shown in the following figures. The same parts are provided with the same reference signs and the same component designations. Furthermore, some features or combinations of features from the various embodiments shown and described may also represent independent, inventive solutions or solutions in accordance with the invention. It is shown by:

FIG. 1 a perspective view of a connector arrangement for the preferred application of a coaxial contact system;

FIG. 2 a sectional view of a detail of the connector arrangement shown in FIG. 1;

FIG. 3 an enlarged detailed view of FIG. 2;

FIG. 4 a schematic cross-sectional view of a coaxial contact system according to a first example;

FIG. 5 a schematic sectional view of the current flow through the coaxial contact system according to FIG. 4;

FIG. 6 a schematic sectional view of a coaxial contact system according to a second example;

FIG. 7 a schematic sectional view of a coaxial contact system according to a third example;

FIG. 8 a schematic perspective view of a coaxial contact system according to a further example;

FIG. 9 a schematic sectional view of the arrangement shown in FIG. 8;

FIG. 10a schematic sectional view of a coaxial contact system according to a further example.

### DETAILED DESCRIPTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. In various applications, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

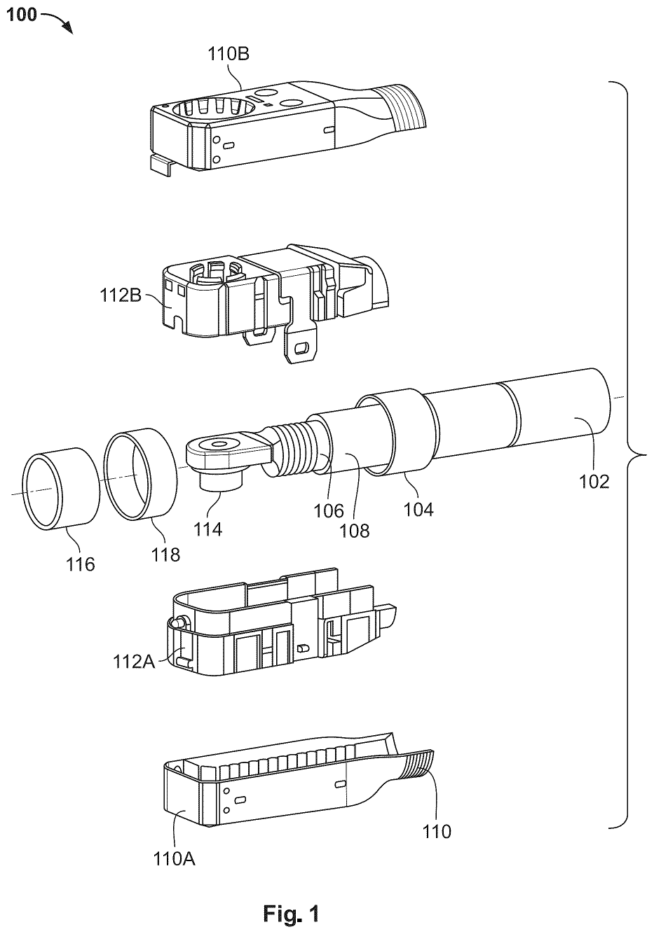

FIG. 1 shows a perspective view of the application of the coaxial contact system according to the invention for connecting a cable shielding to the shield of a connector. However, it should be emphasized that the principles outlined below can also be used for any other application in which the outer conductors of two coaxial conductors are to be connected to each other in an electrically conductive manner.

FIG. 1 shows a partially exploded perspective view of a high-performance connector 100, which is used, for example, for connecting a mating plug on a battery connection (not shown) to a cable 102 in a car. The cable 102 has a shielding 104, which can be formed, for example, by a solid aluminum tube.

The cable shielding 104 concentrically surrounds an inner conductor 106. The cable shielding 104 is separated from the inner conductor 106 by a first insulation layer 108. A connector with a contact element 114 surrounded by a connector shielding 110 is provided for connecting the inner conductor 106 to a battery (not shown).

In the high-performance connector 100 shown, the connector shielding 110 is formed by two half-shells 110A and 110B. The electrical insulation from the contact element 114 is provided by two insulating bodies 112A, 112B, which are also formed as half-shells and form an insulating body 112 that encloses the contact element 114.

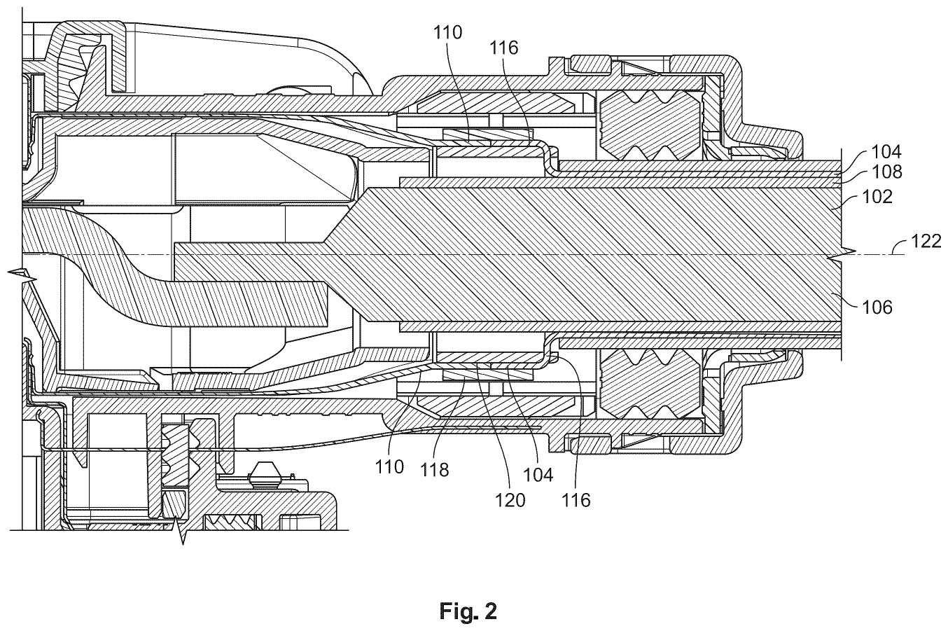

The shielding 104 must be firmly and electrically connected to both half-shells 110A, 110B of the connector shielding 110. For this purpose, as is even more clearly shown in FIG. 2, an inner contact sleeve 116 and an outer contact sleeve 118 are provided. The outer contact sleeve 118 forms a crimp sleeve and is crimped to the two shieldings 104, 110 for final assembly and contacting.

The connector shielding 110, for example, can be formed from a copper-nickel-silicon alloy. Copper alloys that contain nickel and silicon are characterized by corrosion resistance and excellent mechanical and electrical properties. The inner conductor 106 of the cable 102 can, for example, be a solid aluminum conductor.

FIG. 2 illustrates in the form of a sectional view of the high-performance connector 100 the contacting of the two shieldings 104, 110 according to the present invention in detail.

According to the invention, the connector shielding 110 and the cable shielding 104 are arranged next to each other on the inner contact sleeve 116 along a longitudinal axis 122. In contrast to known arrangements, the connector shielding 110 and the cable shielding 104 do not overlap, thus do not form a stacked structure. The inner contact sleeve 116 forms a support sleeve that withstands the mechanical pressure of the crimping process.

Furthermore, in the exemplary embodiment shown, the contact area of the inner contact sleeve 116 that is in contact with the connector shielding 110 and the cable shielding 104 is provided with a microstructured contact area 120.

The microstructured contact area 120 can be generated by a wide range of methods in the general case as a kind of roughness.

For example, embossing, engraving, notching, knurling, punching or similarly processed surfaces may be provided to reduce the electrical resistance to the shieldings 104, 110 to be contacted. The microstructured contact area 120 can thereby be integrally made from the material of the sleeve (also referred to as a ferrule).

Alternatively or additionally, an additive further material on the ferrule can form the microstructured contact area 120.

In addition to the application of bumps, depressions such as punching or a screen plate with small holes that have a punched edge can also be used to create the required roughness.

In a particularly preferred embodiment, the microstructured contact area 120 is at least partially formed by a cold sprayed surface structuring. As already mentioned, the so-called cold spray method is a thermal spray process in which, for example, metallic layers are applied to the base material by means of molten and highly accelerated particles. The impacting particles form a firmly adhering, dense and low-oxide layer with a defined surface roughness, without heating the sleeve to any significant degree.

This coating of the inner contact sleeve 116 allows efficient 360° all-round contacting of the connector shielding 110 and the cable shielding 104. Due to the fact that the connector shielding 110 and the cable shielding 104 are placed next to each other on the surface of the inner contact sleeve 116, considerably less space is required in a direction transverse to the longitudinal axis 122 than in conventional sandwich arrangements.

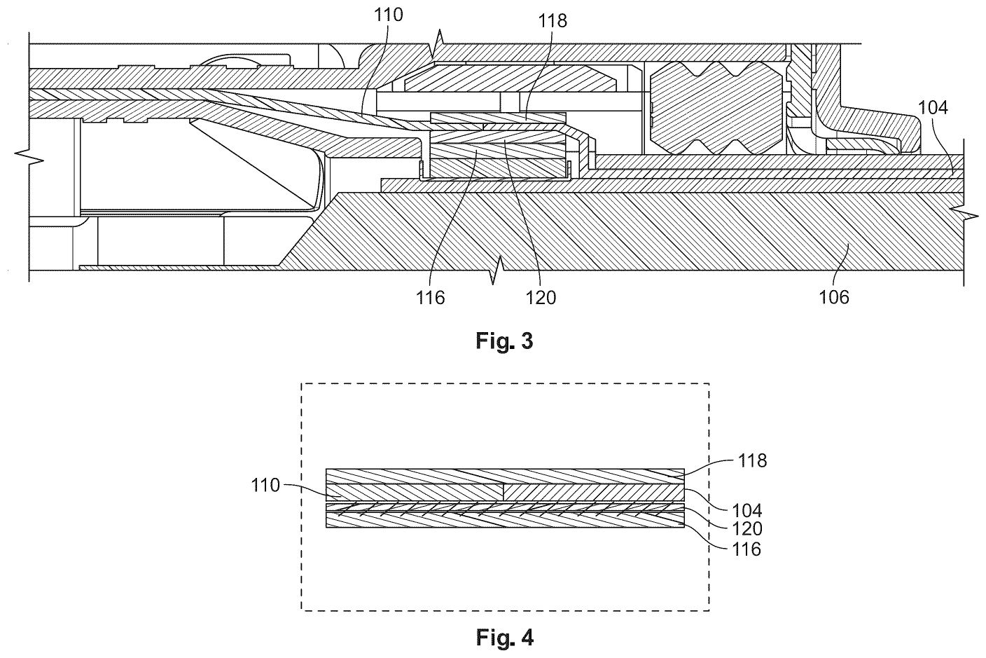

FIG. 3 illustrates the arrangement from FIG. 2 in yet a larger view.

Furthermore, the actual crimping area is shown again in detail in FIG. 4. According to the embodiment shown, the outside of the inner sleeve 116 is provided with a microstructured contact area 120. The microstructured contact area forms the interface with both the connector shielding 110 and the cable shielding 104.

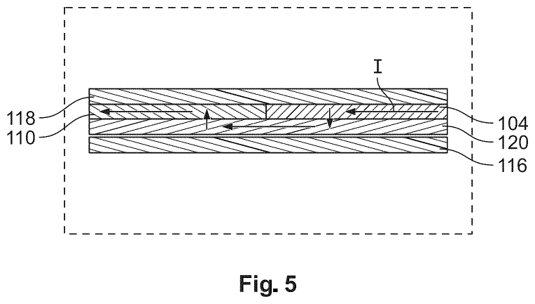

Accordingly, a current flow develops as shown in FIG. 5. The microstructured contact area 120 enables the inner contact sleeve 116 to function as a connection element between the connector shielding 110 and the cable shielding 104 in a particularly efficient manner.

In this case, both the connector shielding 110 and the cable shielding 104 are connected to the inner contact sleeve 116 and in particular to its microstructured contact area 120. The required current flow thus does not take place directly between the connector shielding 110 and the cable shielding 104, but via the inner contact sleeve 116. This ensures that, in the case of a wire braid, each individual wire is electrically contacted and that this contact is made over a sufficient length. In addition, the length of the contact area can be optimized over the length of the outer contact sleeve 118. In particular, if a microstructured contact area 120 is provided, it can also be achieved in the case of an aluminum braid that the oxide layer of each wire is penetrated.

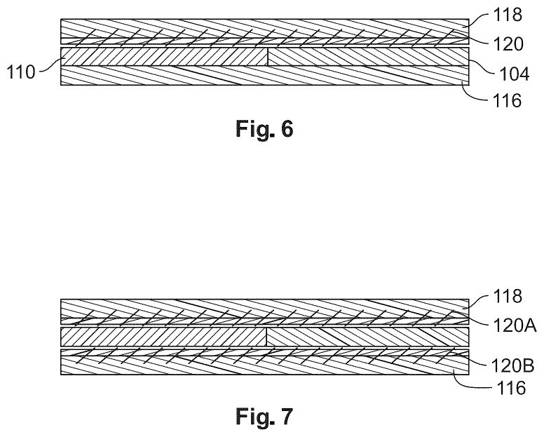

Alternatively, a microstructured contact area 120 can also be provided on the inside of the outer contact sleeve 118. This embodiment is shown in a highly schematized form in FIG. 6.

Finally, there is also the option of providing a first microstructured contact area 120A on the outside of the inner contact sleeve 116 and a second microstructured contact area 120B on the inside of the outer contact sleeve 118. This embodiment may have the disadvantage that the production of the inner contact sleeve 116 and the outer contact sleeve 118 is more expensive, but on the other hand it has the advantage that the electrical contact and the stability against vibrations and thermal stress is particularly high.

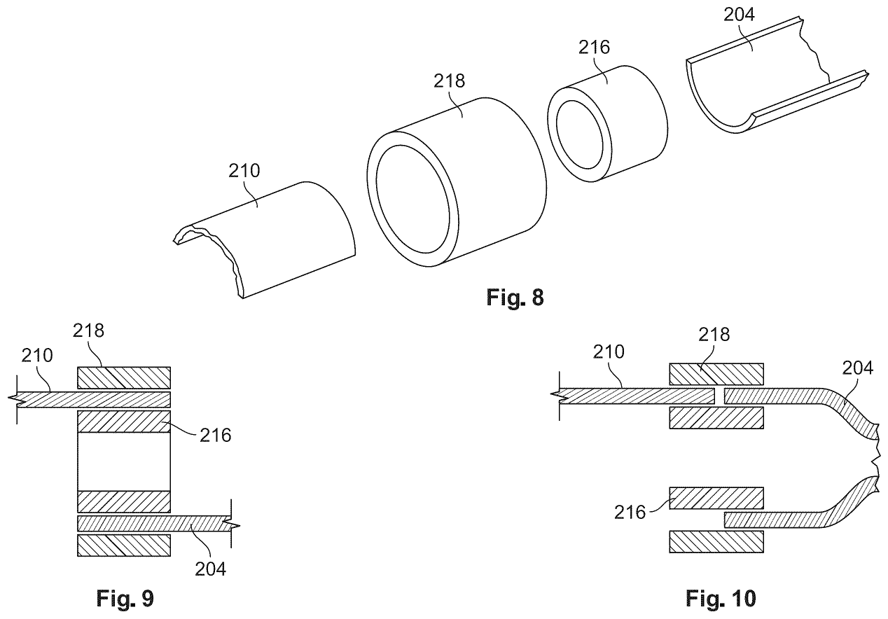

With reference to FIGS. 8 and 9, a further embodiment of the present invention is now explained in which the first outer conductor 210 and the second outer conductor 204 do not cover the full circumference of 360° in the circumferential direction, but only a smaller circumferential range, preferably less than 180°. This means that the first outer conductor 210 and the second outer conductor 204 are arranged next to each other in the circumferential direction. The first outer conductor 210 and the second outer conductor 204 may touch, but are not required to do so. The radially adjacent arrangement shown in FIGS. 8 and 9 can, in a preferred embodiment, enable a significantly shorter construction in the axial direction.

In this case, the surface treatments of the inner contact sleeve 216 and the outer contact sleeve 218 can be carried out analogously to the embodiments shown in FIGS. 4 to 7.

For example, if the first outer conductor 210 covers less than 360° of the circumference, such a configuration is nevertheless compatible with a second outer conductor 204 that covers more than 180° of the circumference, e.g. 360° in the case of a shielding braid, if axial displacement is provided as shown in FIG. 10.

Alternatively, a significantly reduced space requirement in the radial direction can also be achieved by configuring the inner contact sleeve and/or the outer contact sleeve in such a way that they are integral with the first outer conductor or the second outer conductor. In other words, either the first or the second contact sleeve, or both, is not provided as a separate component, but is an integral part of the first or second outer conductor. The microstructured surface can then be provided on the inner or outer surface of the area of the first and/or second outer conductor to be connected, according to the principles described above.

In summary, the present invention offers the advantage that the overall construction size of the coaxial contact system can be reduced and, in particular, the outer diameter of the crimp sleeve is reduced because no stacked structure is provided for the two outer conductors to be connected (e.g. the connector shielding and the cable shielding).

By separating the two outer conductors to be connected either axially or radially, each of the two contact zones can be optimized with regard to the individual requirements.

In addition, the solution according to the invention allows the actual electrical contact area to be transferred to the significantly more robust inner ferrule and no longer to the surface of the connector shielding, which is more fragile in most cases.

The number of process steps is greatly reduced and the type of outer conductor to be connected can be adapted as required.

It has been shown that satisfactory electromagnetic compatibility can also be achieved with aluminum braids. The reason for this is the improved electrical contact to the aluminum wires. The current flow is improved and the impedance is reduced.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A coaxial contact system for electrically connecting a first outer conductor of a first coaxial conductor to a second outer conductor of a second coaxial conductor, wherein the coaxial contact system comprises:
an inner contact sleeve which forms a support sleeve,
an outer contact sleeve which at least partially surrounds the inner contact sleeve and forms a crimp sleeve which is crimped around the first and second outer conductors in a final assembled state,
wherein the inner contact sleeve and the outer contact sleeve are designed such that the first outer conductor is arranged in an axial direction or a radial direction next to the second outer conductor on the inner contact sleeve.

2. The coaxial contact system according to claim 1, wherein the inner contact sleeve and/or the outer contact sleeve have a microstructured contact area which, in the final assembled state, electrically contacts the first and/or the second outer conductor.

3. The coaxial contact system according to claim 2, wherein the microstructured contact area is at least partially formed integrally with the inner and/or outer contact sleeve.

4. The coaxial contact system according to claim 2, wherein the microstructured contact area is at least partially configured as an additional coating of the inner and/or outer contact sleeve.

5. The coaxial contact system according to claim 2, wherein the microstructured contact area is at least partially formed by an embossing, a punching, and/or a screen plate.

6. The coaxial contact system according to claim 2, wherein the microstructured contact area is at least partially formed by a cold sprayed surface structuring.

7. A coaxial contact system for electrically connecting a first outer conductor of a first coaxial conductor to a second outer conductor of a second coaxial conductor, wherein the coaxial contact system comprises:
an inner contact sleeve which forms a support sleeve,
an outer contact sleeve which at least partially surrounds the inner contact sleeve and forms a crimp sleeve which is crimped around the first and second outer conductors in a final assembled state,
wherein the inner contact sleeve and/or the outer contact sleeve are configured such that they are integral with the first outer conductor or the second outer conductor.

8. The coaxial contact system according to claim 7, wherein the inner contact sleeve and/or the outer contact sleeve have a microstructured contact area which, in the final assembled state, electrically contacts the first and/or the second outer conductor.

9. The coaxial contact system according to claim 8, wherein the microstructured contact area is at least partially formed integrally with the inner and/or outer contact sleeve.

10. The coaxial contact system according to claim 8, wherein the microstructured contact area is at least partially configured as an additional coating of the inner and/or outer contact sleeve or is at least partially formed by a cold sprayed surface structuring.

11. The coaxial contact system according to claim 8, wherein the microstructured contact area is at least partially formed by an embossing, a punching, and/or a screen plate.

12. A method for electrically connecting a first outer conductor of a first coaxial conductor to a second outer conductor of a second coaxial conductor, wherein the method comprises the following steps:
attaching an inner contact sleeve so that it is arranged in a radial direction below the first outer conductor and the second outer conductor,
attaching an outer contact sleeve so that it at least partially surrounds the inner contact sleeve and forms a crimp sleeve, and
crimping the outer contact sleeve so that it is crimped onto the first outer conductor and the second outer conductor.
wherein the first outer conductor is arranged on the inner contact sleeve next to the second outer conductor in an axial direction or a radial direction, and/or
wherein the inner contact sleeve and/or the outer contact sleeve are configured such that they are integral with the first outer conductor or the second outer conductor.

13. The method according to claim 12, wherein the inner contact sleeve and/or the outer contact sleeve are provided with a microstructured contact area which, in the final assembled state, electrically contacts the first and/or the second outer conductor.

14. The method according to claim 13, wherein the microstructured contact area is at least partially formed integrally with the inner and/or outer contact sleeve.

15. The method according to claim 13, wherein the microstructured contact area is at least partially configured as an additional coating of the inner and/or outer contact sleeve.

16. The method according to claim 13, wherein the microstructured contact area is at least partially formed by an embossing, a punching, an electroplating and/or a separate screen plate.

17. The method according to claim 13, wherein the microstructured contact area is at least partially formed by a cold sprayed surface structuring.

18. The method according to claim 13, wherein the first outer conductor is formed by the shielding of a connector.

19. The method according to claim 13, wherein the second outer conductor is formed by the shielding of a cable.

20. The method according to claim 19, wherein the shielding of the cable comprises an aluminum wire braid.
